(19) United States
(12) Patent Application Publication
(10) Pub. No.: US 2009/0157282 A1
(43) Pub. Date: Jun. 18, 2009

(54) Air-Fuel Ratio Control Apparatus by Sliding Mode Control of Engine

(75) Inventors: Seiji Asano, Hitachinaka (JP); Yasukuni Kubo, Kamisato (JP); Takayuki Ohbu, Isesaki (JP); Keiichi Takayanagi, Isesaki (JP); Shigeo Ohkuma, Isesaki (JP); Shunji Fukui, Hitachinaka (JP); Junichi Noda, Naka (JP)

Correspondence Address: CROWELL & MORING LLP;INTELLECTUAL PROPERTY GROUP, P.O. BOX 14300, WASHINGTON, DC, 20044-4300, US

(73) Assignee: Hitachi, Ltd., Tokyo (JP)

(21) Appl. No.: 12/261,876

(22) Filed: Oct. 30, 2008

(30) Foreign Application Priority Data
Dec. 12, 2007 (JP) 2007-320316

(51) Int. Cl. F02D 41/00

(52) U.S. Cl. 701/109

(57) ABSTRACT

Factors affecting the response time of a transfer system from the combustion of injected fuel to the detection of its oxygen concentration include a stroke delay time due to an engine speed, the dependence of an LAF sensor response time on an exhaust gas flow rate, a response time change of the LAF sensor due to its deterioration with time, and the like. If a hyperplane of the sliding mode is fixed without considering the above-mentioned factors affecting the response time of the transfer system, an overshoot or oscillation of a feedback system may occur at low speeds of the engine even if preferable feedback responsiveness can be achieved, for example, at high speeds of the engine. This results in aggravated exhaust emissions, degraded drivability due to torque fluctuations, and fluctuations in idle speed.

A hyperplane used in a control system for providing feedback control of an air-fuel ratio through sliding mode control is varied based on the factors affecting the response time of the control system within a range in which the control system can be stabilized.

### BACKGROUND OF THE INVENTION

1. Field of the Invention

The present invention relates to a fuel control apparatus of an engine and more particularly to control an air-fuel ratio using sliding mode control.

2. Description of the Related Art

When a target air-fuel ratio is in a rich range, variations of an actual air-fuel ratio relative to the target air-fuel ratio become greater. A known technique as disclosed in JP-A-2007-247426 thus makes the limit amount of a feedback factor from the sliding mode control greater than that during the state of the stoichiometric air-fuel ratio by setting the inclination of a switching function (a switching hyperplane according to an aspect of the present invention) to a value smaller than that during a time period other than the rich mode.

### SUMMARY OF THE INVENTION

It is an object of the present invention to achieve through the sliding mode control an appropriate feedback gain for a transfer system based on changes in a delay time of the transfer system during the period from the injection of fuel to the detection of its oxygen concentration.

A range of a hyperplane in which the transfer system can be maintained in a stable state (converging on a target without oscillating or diverging) is first determined, and then the hyperplane is made variable within that range. The transfer system is to have a delay time as affected by stroke delay due to an engine speed (delay of an exhaust gas in reaching an LAF sensor), the dependence of the LAF sensor response on a flow rate of the exhaust gas, and changes in response time of the LAF sensor due to deterioration with time or the like. The rising speed and convergence of the sliding mode control at the time of a target change can be determined based on the magnitude relation between elements constituting the hyperplane (designated as S1 and S2 in the present application) within a range in which the stability of the transfer system can be maintained. An optimum transient response can therefore be achieved by determining the elements constituting the hyperplane based on the factors affecting the delay time of the transfer system.

Since an optimum transient response can be achieved in each operating range of the engine (low to high engine speed and small to large intake air amount), an overshoot of an air-fuel ratio with respect to a target air-fuel ratio and delay of the air-fuel ratio in reaching that target air-fuel ratio can be suppressed, whereby exhaust emissions can be prevented from being aggravated. In addition, a phenomenon in which the actual air-fuel ratio somewhat oscillates with respect to the target air-fuel ratio can be prevented, so that a driver can drive the vehicle without feeling torque fluctuations. Further, fluctuations in idle speed due to variations in air-fuel ratio convergence can be suppressed.

Since feedback response is changed according to the response delay time of the LAF sensor, deterioration of exhaust emissions due to deterioration of the LAF sensor with time or the like can also be suppressed.

An aspect of the present invention thus provides a control apparatus for an engine, comprising: means for detecting the oxygen concentration of an exhaust gas of the engine; means for calculating a target air-fuel ratio according to the operating state of the engine; means for providing feedback control by sliding mode control to achieve the target air-fuel ratio using the output from the means for detecting the oxygen concentration; means for considering a transfer system during the time interval between when injected fuel is burned and when the oxygen concentration is detected; means for storing in advance a range of a hyperplane in which the sliding mode control is stable; and means for varying a hyperplane according to the state of the transfer system.

### BRIEF DESCRIPTION OF THE DRAWINGS

FIG. 1 is a typical control block diagram of a fuel control apparatus according to an embodiment of the present invention.

FIG. 2 shows an example of an engine and its surrounding components controlled by the fuel control apparatus according to the embodiment of the present invention.

FIG. 3 shows another example of the engine and its surrounding components controlled by the fuel control apparatus according to the embodiment of the present invention.

FIG. 4 is a typical internal configuration of the fuel control apparatus according to the embodiment of the present invention.

FIG. 5 is a typical control block diagram for air-fuel ratio feedback of the fuel control apparatus according to the embodiment of the present invention.

FIG. 6 is a typical block diagram for determining a nonlinear gain of the fuel control apparatus according to the embodiment of the present invention.

FIG. 7 is a typical block diagram for determining a hyperplane of the fuel control apparatus according to the embodiment of the present invention.

FIG. 8 is a typical block diagram for finally determining the hyperplane of FIG. 7.

FIG. 9 is a diagram showing an example of the time required for an exhaust gas to reach a sensor of the engine according to the embodiment of the present invention.

FIG. 10 is a diagram showing an example of the dependence of the response time of an LAF sensor according to the embodiment of the present invention on an exhaust gas flow rate.

FIG. 11 is a diagram showing a typical setting of a hyperplane of the fuel control apparatus according to the embodiment of the present invention.

FIG. 12 is a diagram showing typical behaviors of a target air-fuel ratio and an actual air-fuel ratio of an engine including the fuel control apparatus according to the embodiment of the present invention.

FIG. 13 is a flowchart showing typical general control of the fuel control apparatus according to the embodiment of the present invention.

FIG. 14 is a flowchart showing details of the block diagram of FIG. 5.

FIG. 15 is a flowchart showing details of the block diagram of FIG. 6.

FIG. 16 is a flowchart showing details of the block diagram of FIG. 7.

FIG. 17 is a flowchart showing details of the block diagram of FIG. 8.

### DESCRIPTION OF THE PREFERRED EMBODIMENTS

1. First Embodiment

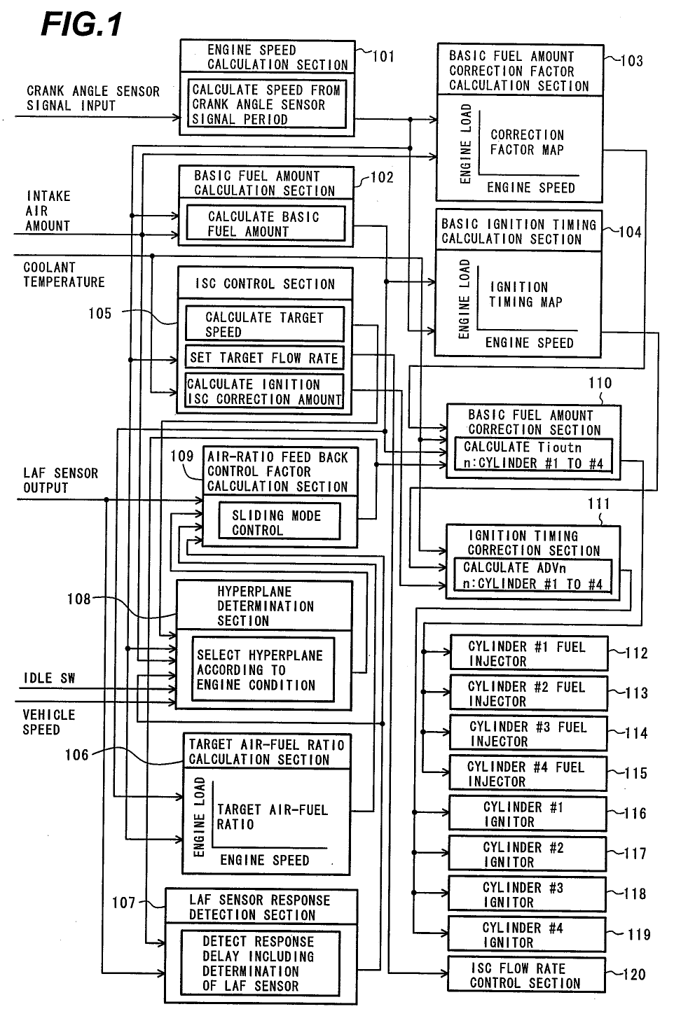

Embodiments of the present invention will be described below with reference to the accompanying drawings. FIG. 1 is a typical control block diagram of a fuel control apparatus employing a method for feedback controlling an air-fuel ratio of fuel, to which the present invention is applied.

A block 101 is an engine speed calculation section. The block 101 counts the number of inputs of changes in electric signal per unit time, typically a pulse signal, of a crank angle sensor disposed at a predetermined angle in an engine. The block 101 then performs arithmetic operations of the count to find the engine speed per unit time. A block 102 calculates a basic fuel amount required by the engine in each operating range based on the engine speed calculated by the block 101 and an airflow rate drawn in by the engine. A block 103 calculates a correction factor of the basic fuel amount calculated in the block 102 in each operating range of the engine, using the engine speed calculated in the block 101 and the basic fuel amount as engine loads. A block 104 determines an optimum ignition timing in each operating range of the engine through map search or the like based on the engine loads of the engine speed and the basic fuel amount. A block 105 sets a target idle speed in order to maintain a predetermined level of the engine idle speed and calculates a target flow rate and an ISC ignition timing correction amount for an ISC valve control section. A block 106 determines an optimum target air-fuel ratio according to the engine operating range based on the engine loads of the engine speed and the basic fuel amount. A block 107 calculates a response delay based on an output from an air-fuel ratio sensor provided on an engine exhaust pipe and the behavior of an air-fuel ratio feedback factor to be described later, the response delay including a delay due to a deterioration of the air-fuel ratio sensor. A block 108 finds a hyperplane of a sliding mode control from the response delay of the air-fuel ratio sensor, the engine speed, an intake air amount, the target idle speed, a vehicle speed, an idle switch, and the like. A block 109 calculates, from the hyperplane found by the block 108, the air-fuel ratio sensor output, and the target air-fuel ratio established by the block 106, a feedback factor required for achieving a desirable air-fuel ratio with the sliding mode control as a core. A block 110 corrects the basic fuel amount calculated by the block 102, using the correction factor calculated by the block 103, a correction factor according to an engine coolant temperature, the air-fuel ratio feedback factor found by the block 109, and the like. A block 111 corrects the basic ignition timing determined by the block 104, using the ISC ignition timing correction amount of the block 105, the correction factor according to the engine coolant temperature, and the like. Blocks 112 to 115 are fuel injectors that supply the engine with fuel based on the fuel amount calculated by the block 110. Blocks 116 to 119 are igniters that ignite a fuel mixture flowing into a cylinder according to the required ignition timing of the engine corrected by the block 111. A block 120 is an actuator that drives the ISC valve so as to achieve the target flow rate during idling calculated by the block 105. In accordance with the embodiment of the present invention, the basic fuel amount calculated from the intake air amount represents the engine load; however, a negative pressure inside the intake pipe may represent the engine load.

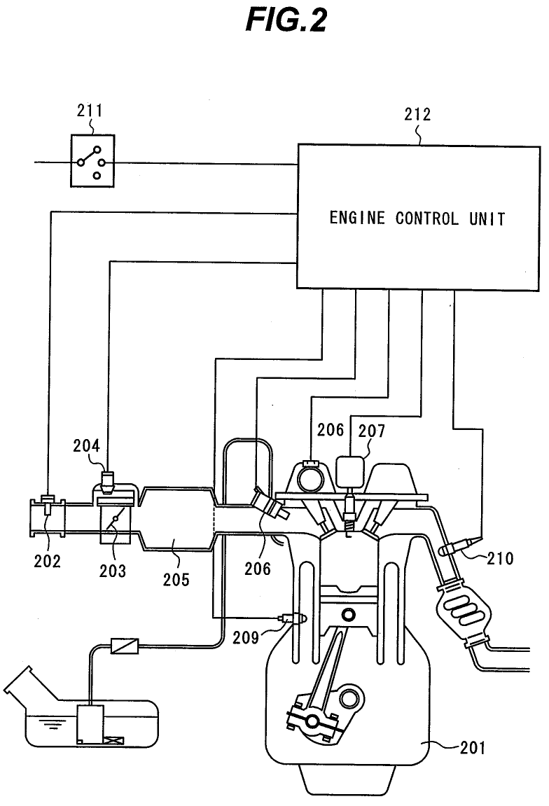

FIG. 2 shows an example of the engine and its surrounding components controlled by the fuel control apparatus employing the method for feedback controlling the air-fuel ratio of fuel, to which the present invention is applied.

An engine 201 includes a thermal air flow meter 202, a throttle valve 203, an idle speed control valve 204, a fuel injection valve 206, a cam angle sensor 207, an ignition module 208, a coolant temperature sensor 209, an air-fuel ratio sensor 210, an ignition key switch 211, and an engine control unit 212. Specifically, the thermal air flow meter 202 measures the amount of air drawn in. The throttle valve 203 regulates the rate of an airflow drawn into the engine. The idle speed control valve 204 controls the engine idle speed by controlling the area of a flow path that bypasses the throttle valve 203 and connects to an intake pipe 205. The fuel injection valve 206 supplies a fuel of a particular amount requested by the engine 201. The cam angle sensor 207 is disposed at a predetermined cam angle of the engine 201. The ignition module 208 supplies an ignition plug that ignites a fuel mixture supplied into an engine cylinder with ignition energy based on an ignition signal of the engine control unit 212. The coolant temperature sensor 209 is provided on a cylinder block of the engine 201 to detect an engine coolant temperature. The air-fuel ratio sensor 210 is disposed upstream of a catalyst of an engine exhaust pipe. The air-fuel ratio sensor 210 outputs an electric signal that is linear relative to the oxygen concentration of an exhaust gas. The ignition key switch 211 serves as a main switch for running and stopping the engine 201. The engine control unit 212 controls auxiliaries of the engine 201. The idle speed control valve 204, which controls the engine idle speed, is not necessary if the throttle valve 203 is to be controlled by a motor or the like. In accordance with the first embodiment of the present invention, fuel control is accomplished by detecting the amount of air drawn into the engine 201; however, the fuel control can also be achieved by detecting an intake pipe pressure.

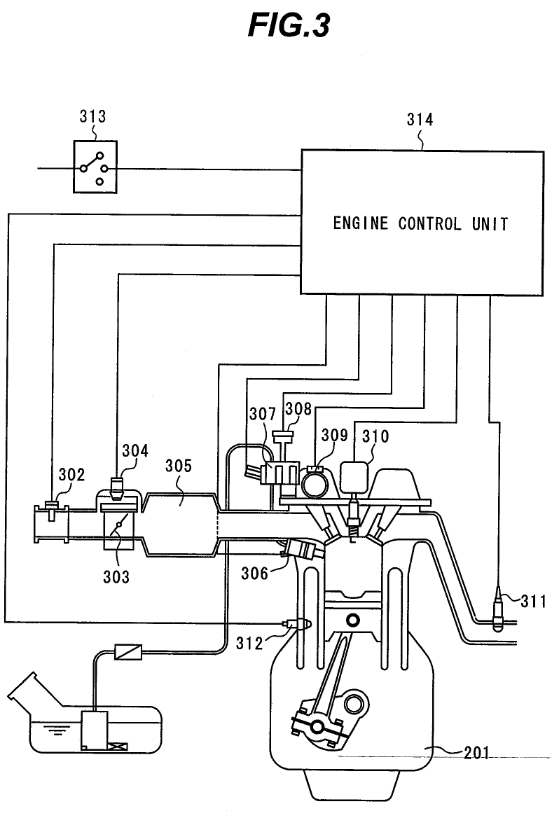

FIG. 3 shows a second example of the engine and its surrounding components controlled by the fuel control apparatus employing the feedback control method for controlling the air-fuel ratio of fuel, to which the present invention is applied.

The second example shown in FIG. 3 differs from the first example shown in FIG. 2 in that a fuel injection valve 306 is not disposed upstream of an intake valve but connected to an engine cylinder. The fuel injection valve 306 thereby injects fuel directly into the cylinder. Because of this arrangement, the second example additionally includes a high pressure fuel pump 307 for boosting a fuel pressure and a fuel pressure sensor 308.

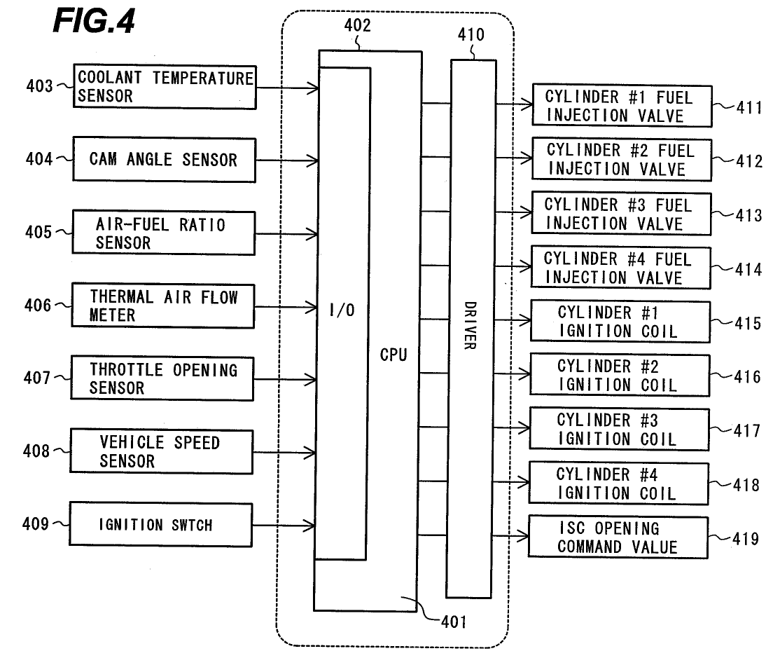

FIG. 4 is a typical internal configuration of the fuel control apparatus employing the feedback control method for controlling the air-fuel ratio of fuel, to which the present invention is applied. A CPU 401 includes an I/O section 402 that converts electric signals of the sensors provided in the engine 201 to corresponding signals for digital arithmetic operations and the digital arithmetic operation control signals to corresponding actual actuator drive signals. The I/O section 402 receives inputs from a coolant temperature sensor 403, a cam angle sensor 404, an air-fuel ratio sensor 405, an intake airflow rate sensor 406, a throttle opening sensor 407, a vehicle speed sensor 408, and an ignition switch 409. Output signals are transmitted from the CPU 401 to fuel injection valves 411 to 414, ignition coils 415 to 418, and an ISC opening command value 419 for an ISC valve via an output signal driver 410.

Basic equations for finding an air-fuel ratio feedback control factor (air-fuel ratio feedback factor) of the engine that employs the feedback control method for controlling the air-fuel ratio of fuel according to the first embodiment of the present invention will be given below. Expression 1 represents a transfer function of the air-fuel ratio sensor. A fuel-air ratio of a fuel injection amount and a fuel-air ratio detected by the air-fuel ratio sensor may be represented by Expression 1 that includes the transfer function of the air-fuel ratio sensor. It is to be noted that the fuel-air ratio is a normalized value, given by the fuel amount divided by the air amount, the divided amount further multiplied by the stoichiometric air-fuel ratio (about 14.5) (which is referred to as the fuel-air ratio).

$$y ( z ) = \frac{1}{{a}_{0} + {a}_{1} \cdot {z}^{- 1} + {a}_{2} \cdot {z}^{- 2}} \cdot u ( z ) \qquad Expression 1$$

u(z): Injection fuel-air ratio

y(z): LAF sensor output fuel-air ratio

Expressions 2 represent a state space of the air-fuel ratio sensor. Expression 2-(1) is a state equation, and Expression 2-(2) is an output equation. Expressions 2-(1) and 2-(2) are derived from the above-referenced equation 1. Further, x1 and x2 represent internal status variables.

$$\begin{matrix}( \begin{matrix}{x}_{1} ( n + 1 ) \\ {x}_{2} ( n + 1 )\end{matrix} ) = ( \begin{matrix}- \frac{{a}_{1}}{{a}_{0}} & - \frac{{a}_{2}}{{a}_{0}} \\ 1 & 0\end{matrix} ) \cdot ( \begin{matrix}{x}_{1} ( n ) \\ {x}_{2} ( n )\end{matrix} ) + ( \begin{matrix}\frac{1}{{a}_{0}} \\ 0\end{matrix} ) \cdot u ( n ) & Expression 2 \text{-} ( 1 ) \\ y ( n ) = ( \begin{matrix}- \frac{{a}_{1}}{{a}_{0}} & - \frac{{a}_{2}}{{a}_{0}}\end{matrix} ) \cdot ( \begin{matrix}{x}_{1} ( n ) \\ {x}_{2} ( n )\end{matrix} ) + \frac{1}{{a}_{0}} \cdot u ( n ) & Expression 2 \text{-} ( 2 )\end{matrix}$$

x₁,x₂: Internal status variables

Expressions 3 represent a hyperplane, a linear element, a nonlinear element, and a switching hyperplane of the sliding mode control used in the first embodiment of the present invention. Expression 3-(1) defines the hyperplane, given by two numeric values of S1 and S2. Expression 3-(2) represents the linear element, and Expression 3-(3) represents the nonlinear element, both derived from the state space of the above-referenced Expressions 2 and the switching hyperplane to be described later. Expression 3-(4) represents the switching hyperplane. An evaluation value multiplied by the hyperplane is the difference between a current value of the internal status variable and a convergence value of the internal status variable.

$$\begin{matrix}s = ( \begin{matrix}{s}_{1} & {s}_{2}\end{matrix} ) & Expression 3 \text{-} ( 1 ) \\ {u}_{eq} ( n ) = ( ( {a}_{1} + {a}_{0} ) - \frac{{a}_{0}}{{S}_{1}} \cdot {S}_{2} ) \cdot {x}_{1} ( n ) + ( {a}_{2} + \frac{{a}_{0}}{{S}_{1}} \cdot {S}_{2} ) \cdot {x}_{2} ( n ) & Expression 3 \text{-} ( 2 ) \\ {u}_{n 1} = - η \cdot \frac{δ ( n )}{\vert δ ( n ) \vert + ɛ} & Expression 3 \text{-} ( 3 )\end{matrix}$$

η: Nonlinear gain

δ(n)=S·e(n)

When e(n)=(x(n)− x̅(n)), the above δ(n) is then given by

$$= {S}_{1} \cdot ( {x}_{1} ( n ) - {\overline{x}}_{1} ( n ) ) + {S}_{2} \cdot ( {x}_{2} ( n ) - {\overline{x}}_{2} ( n ) ) \\ = {S}_{1} \cdot ( {x}_{1} ( n ) - \frac{u ( n )}{{a}_{0} + {a}_{1} + {a}_{2}} ) + {S}_{2} \cdot ( {x}_{2} ( n ) - \frac{u ( n )}{{a}_{0} + {a}_{1} + {a}_{2}} ) \qquad Expression 3 \text{-} ( 4 )$$

Expressions 4 represent a final output (air-fuel ratio feedback factor) of the sliding mode control used in the first embodiment of the present invention. Expression 4-(1) adds the above-referenced linear element to the nonlinear element to find the air-fuel ratio feedback factor. Expression 4-(2) is a relational expression between S1 and S2 of the hyperplane for stabilizing the sliding mode control according to the first embodiment of the present invention. In a relational area of S1 and S2, in which the Expression 4-(2) holds true, divergence or oscillation of the air-fuel ratio feedback factor does not occur. The stabilization area can be found using the Expression 2-(1) and a switching function, details of which will, however, be omitted.

uₜₒₜₐₗ=u_{eq}(n)+uₙₗ Expression 4-(1)

### Stable Convergence Condition

$$\vert \frac{{s}_{2}}{{s}_{1}} \vert < 1.0 \qquad Expression 4 \text{-} ( 2 )$$

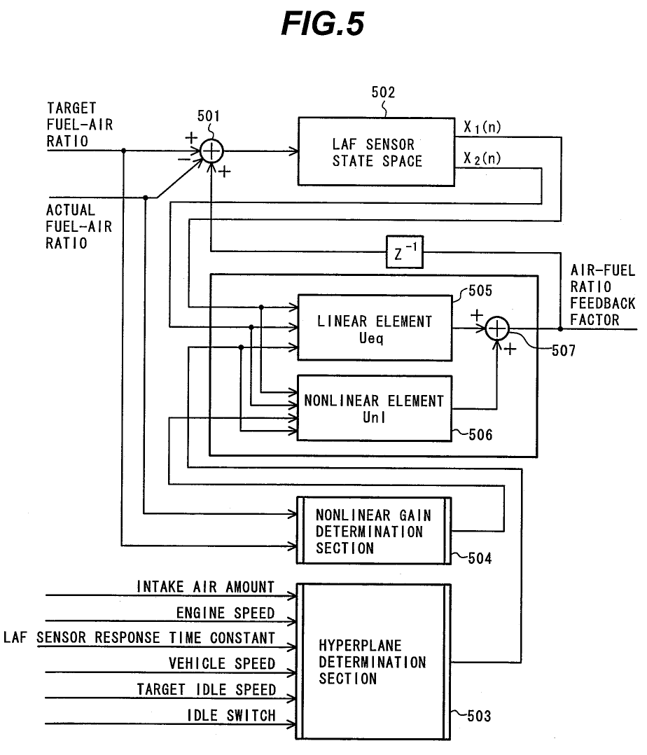

FIG. 5 is a typical control block diagram for air-fuel ratio feedback by the sliding mode control of the engine that employs the feedback control method for controlling the air-fuel ratio of fuel according to the first embodiment of the present invention. An adder 501 adds the air-fuel ratio feedback factor from a preceding sliding mode control process to the difference between a target fuel-air ratio and an actual fuel-air ratio, and the result is applied to an LAF sensor state space of a block 502. The state variables of the LAF sensor are outputted from the LAF sensor state space. A block 503 determines a hyperplane from the intake air amount, the engine speed, an LAF sensor response time constant, the vehicle speed, the target idle speed, and the idle switch. A block 504 determines a nonlinear gain from the target fuel-air ratio and the actual fuel-air ratio. A block 505 calculates a linear element using the LAF sensor state variables and the hyperplane determined by the block 503. A block 506 calculates a nonlinear element using the LAF sensor state variables, the hyperplane, and the nonlinear gain. An adder 507 adds the linear element to the nonlinear element and outputs the result as the air-fuel ratio feedback factor.

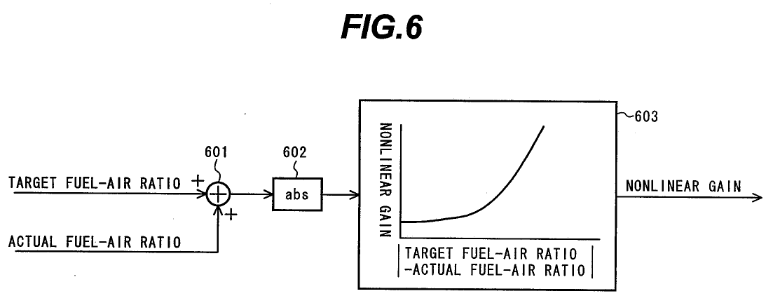

FIG. 6 is a typical block diagram for determining the nonlinear gain by the sliding mode control of the engine that employs the feedback control method for controlling the air-fuel ratio of fuel according to the first embodiment of the present invention.

An adder 601 and a block 602 calculate the absolute value of the difference between the target fuel-air ratio and the actual fuel-air ratio. A block 603 finds the nonlinear gain from the absolute value of the difference through table search.

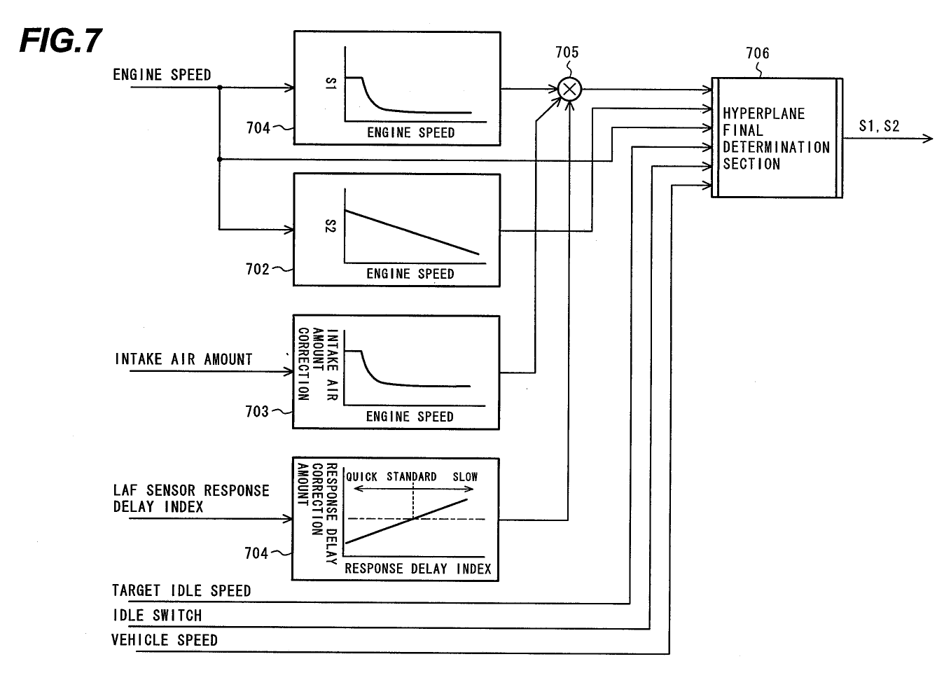

FIG. 7 is a typical block diagram for determining the hyperplane by the sliding mode control of the engine that employs the feedback control method for controlling the air-fuel ratio of fuel according to the first embodiment of the present invention. A block 701 performs a table search for S1 for the hyperplane from the engine speed. A block 702 performs a table search for S2 for the hyperplane from the engine speed. A block 703 performs a table search for intake air amount correction from the intake air amount. This correction is based on the dependence of the LAF sensors responsiveness on an exhaust gas flow rate. A block 704 performs a table search for a response delay correction amount from an LAF sensor response delay index. The LAF sensor response delay index may be obtained from system identification, response to the fuel amount inputted, and the like, details of which will, however, be omitted. A multiplier 705 corrects the SI for the intake air amount correction and the response delay correction. In this example, the correction is made for the S1; however, the S2 or both the S1 and S2 may be corrected. A block 706 is a hyperplane final determination section determining the final hyperplane using the corrected S1, the S2, the engine speed, the target idle speed, the idle switch, the vehicle speed, and the like.

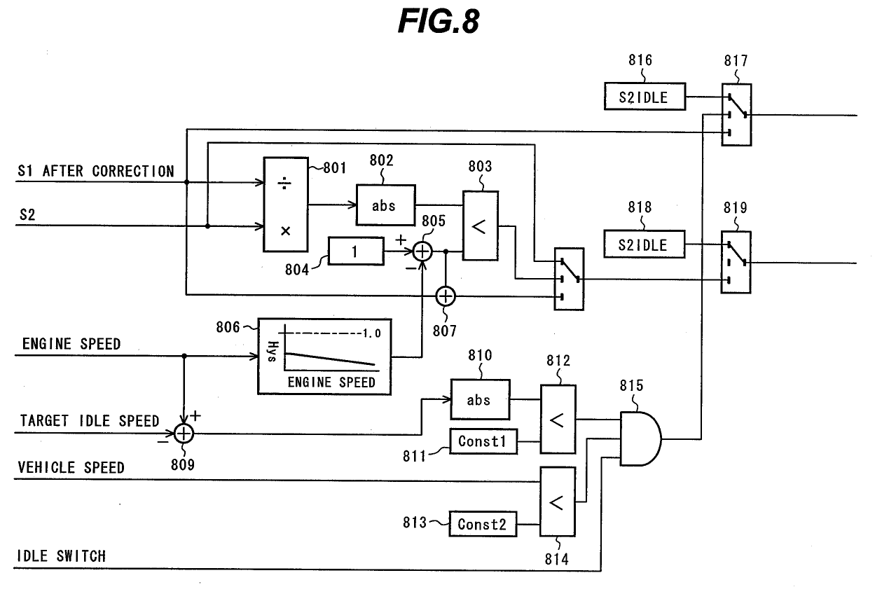

FIG. 8 is a typical detailed control block configuration of the hyperplane final determination section shown in FIG. 7. Blocks 801 and 802 calculate an absolute value of S2/S1. A comparator 803 determines if the absolute value is smaller than a predetermined value or not. The predetermined value is a value obtained by an adder 805 subtracting from the stability limit 1 of the Expression 4-(2) the value of Hys found through a table search at a block 806 based on an engine speed. If the comparator 803 determines that the absolute value is more than the predetermined value, output for S2 is a value obtained by multiplying the value of (1−Hys) by S1 with a multiplier 807 and a switch 808. An adder 809 and a block 810 calculate the absolute value of the difference between the engine speed and the target idle speed. If a comparator 812 determines that the absolute value is smaller than a predetermined value 811, and if a comparator 814 determines that the vehicle speed is smaller than a predetermined value 813, and further if the idle switch is ON, switches 817 and 819 select, as values during idling, preferentially a predetermined value 816 and 818 for S1 and S2, respectively, which have been determined by blocks 801 through 808.

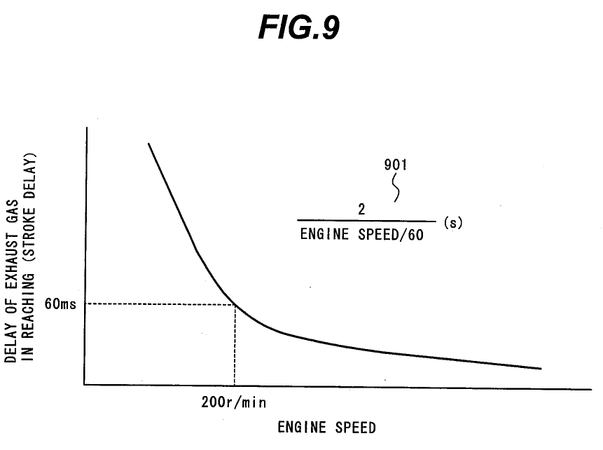

FIG. 9 is a diagram showing the time it takes an exhaust gas to reach the LAF sensor (stroke delay time) with respect to the engine speed in the engine according to the embodiment of the present invention. The delay time exhibits a tendency as shown in FIG. 9 and is represented by Expression 901.

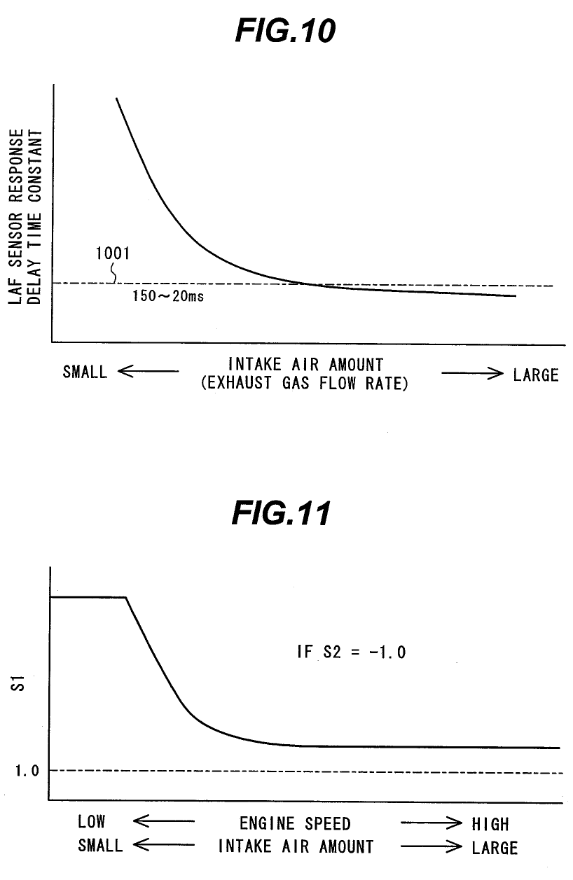

FIG. 10 is a diagram showing an example of the dependence of the time constant of the LAF sensor provided on the engine according to the first embodiment of the present invention on an exhaust gas flow rate. The time constant shows the tendency as shown in FIG. 10, ranging roughly between 150 ms and 200 ms in an ordinary range as indicated by reference numeral 1001. The time becomes longer in a range with a low exhaust gas flow rate.

FIG. 11 is a diagram showing a typical setting tendency of S1 of the hyperplane of the sliding mode control of the engine that employs the feedback control method for controlling the air-fuel ratio of fuel according to the first embodiment of the present invention. S1 is set so as to be greater at smaller engine speeds or with smaller intake air amounts.

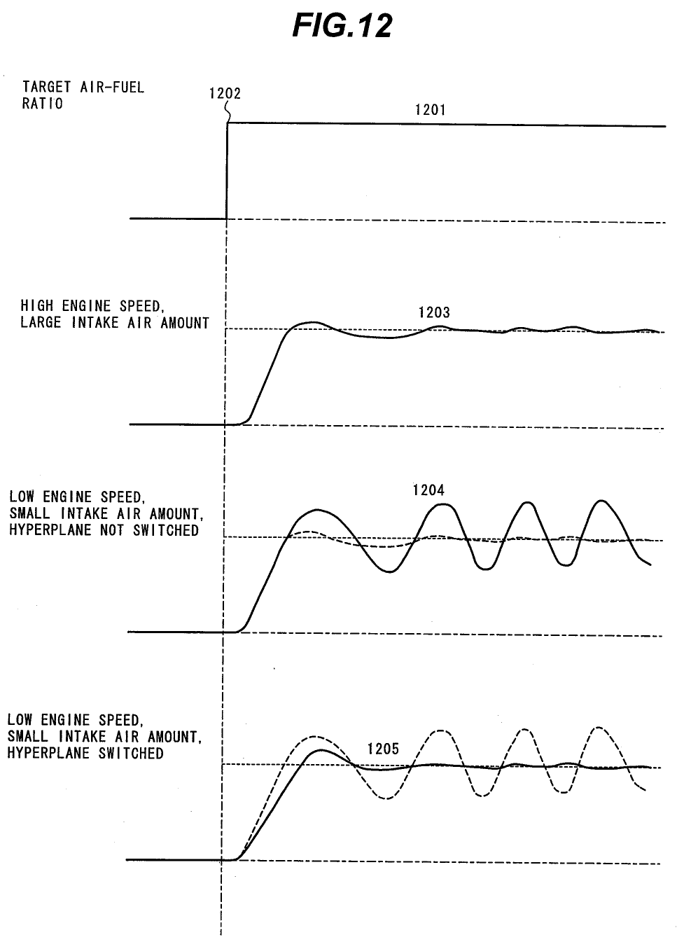

FIG. 12 is a diagram showing typical behavior of the actual air-fuel ratio with changing target air-fuel ratios of the engine that employs the feedback control method for controlling the air-fuel ratio of fuel according to the first embodiment of the present invention. A chart 1201 represents the target air-fuel ratio varied in a stepwise fashion at a time 1202. A chart 1203 shows the actual air-fuel ratio that follows the target air-fuel ratio when the engine speed is high and the intake air amount is great. A chart 1204 shows the behavior of the actual air-fuel ratio when the engine speed is lower and the intake air amount is smaller than with the chart 1203 and when no correction is made for the hyperplane of the chart 1203. As is known from the chart 1204, there is noted a large overshoot relative to the target air-fuel ratio, and the behavior is relatively oscillatory. A chart 1205 shows fluctuations of the actual air-fuel ratio when the hyperplane correction according to the first embodiment of the present invention is made for the hyperplane of the chart 1204. The chart 1205 shows that the overshoots of the chart 1204 are eliminated and the behavior stably follows the target air-fuel ratio.

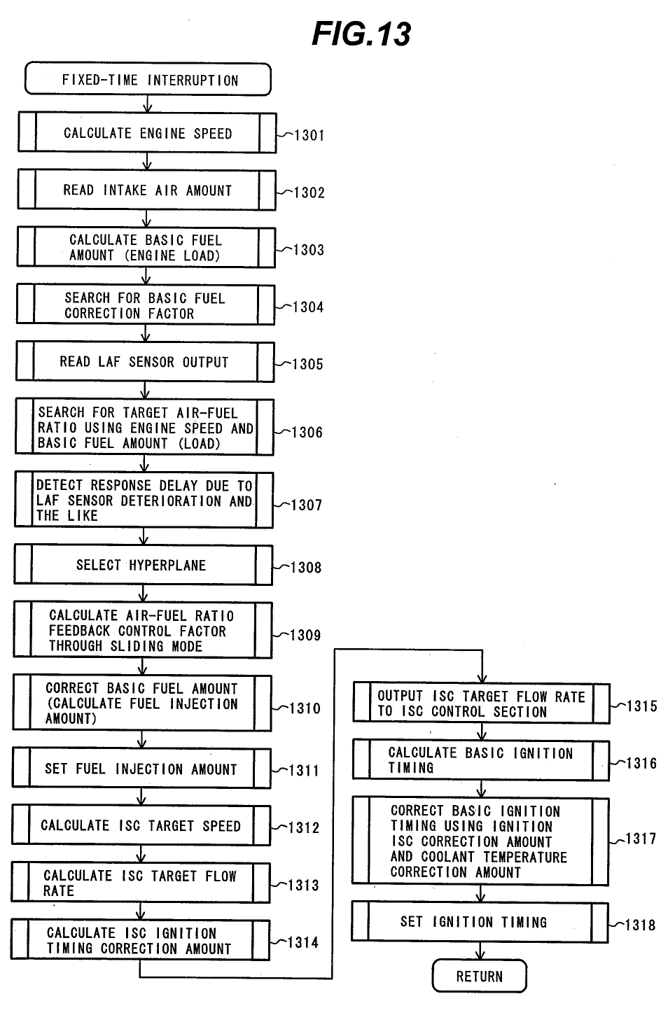

FIG. 13 is a flowchart showing typical control of the fuel control apparatus that employs the feedback control method for controlling the air-fuel ratio of fuel according to the first embodiment of the present invention. In step 1301, the number of inputs of changes in electric signal per unit time, typically a pulse signal, of the crank angle sensor is counted, and the engine speed is calculated through arithmetic operations. In step 1302, the output voltage of the thermal air flow meter is translated to a corresponding airflow rate through voltage-flow rate conversion, and the resultant airflow rate is read. In step 1303, the basic fuel amount is calculated from the engine speed and the intake air amount. In step 1304, a map search is performed for the basic fuel correction factor based on the engine speed and the basic fuel amount. In step 1305, the output voltage of the LAF sensor is subjected to voltage-to-air-fuel-ratio conversion, and the corresponding actual air-fuel ratio is read. In step 1306, a map search is performed for the target air-fuel ratio using the engine speed and the basic fuel amount (load). In step 1307, a response delay including a delay due to a deterioration of the LAF sensor and the like is detected. In step 1308, the hyperplane of the sliding mode control is selected (calculated). In step 1309, the air-fuel ratio feedback factor is obtained through the sliding mode control. In step 1310, the basic fuel amount is corrected using the basic fuel correction factor and the air-fuel ratio feedback factor. In step 1311, the corrected basic fuel amount is set as the fuel injection amount. In step 1312, the target idle speed is set. In step 1313, the target flow rate that can achieve the target idle speed is calculated. In step 1314, an ignition correction amount for suppressing fluctuations in the idle speed is calculated. In step 1315, the target flow rate is outputted to an ISC flow rate control section. In step 1316, a map search is performed for the basic ignition timing using the engine speed and the basic fuel amount (load). In step 1317, the basic ignition timing is corrected using correction factors of the ISC ignition timing, engine coolant temperature, and the like. In step 1318, the ignition timing is set.

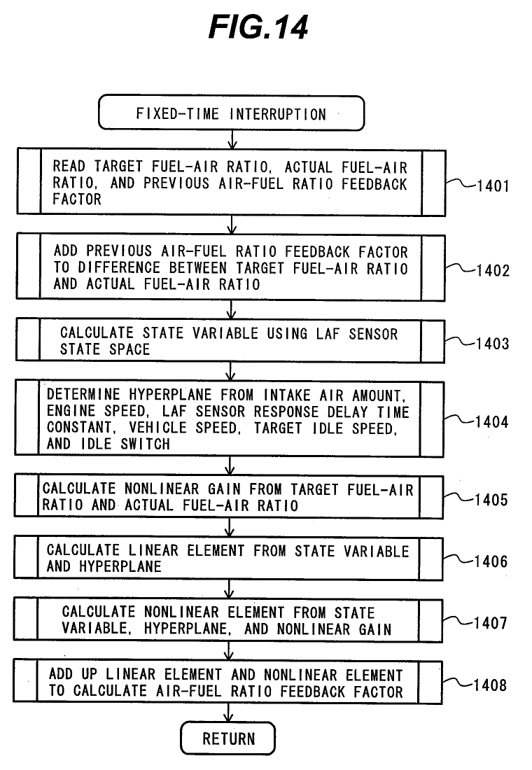

FIG. 14 is a typical flowchart showing details of the block diagram of FIG. 5. In step 1401, the target fuel-air ratio, the actual fuel-air ratio, and the previous air-fuel ratio feedback factor are read. In step 1402, the previous air-fuel ratio feedback factor is added to the difference between the target fuel-air ratio and the actual fuel-air ratio. In step 1403, the resultant sum is inputted to the LAF sensor state space to calculate the LAF sensor state variable. In step 1404, the hyperplane is determined from the intake air amount, the engine speed, the LAF sensor response delay time constant, the vehicle speed, the target idle speed, and the idle switch. In step 1405, a table search is performed for the nonlinear gain using the absolute value of the difference between the target fuel-air ratio and the actual fuel-air ratio. In step 1406, a linear element is calculated from the state variable and the hyperplane. In step 1407, a nonlinear element is calculated from the state variable, the hyperplane, and the nonlinear gain. In step 1408, the linear element and the nonlinear element are added up to calculate the air-fuel ratio feedback factor.

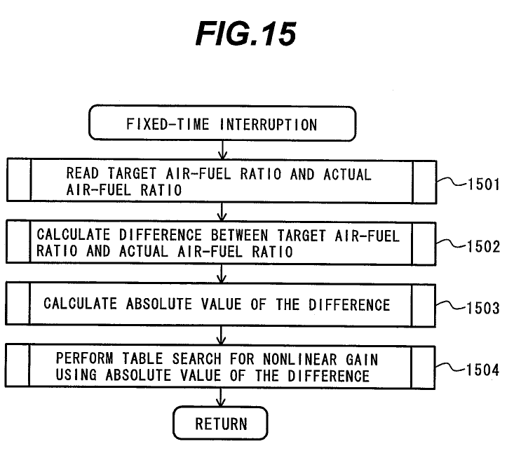

FIG. 15 is a typical flowchart showing details of the block diagram of FIG. 6. In step 1501, the target fuel-air ratio and the actual fuel-air ratio are read. In step 1502, the difference between the target fuel-air ratio and the actual fuel-air ratio is calculated. In step 1503, the absolute value of the difference is calculated. In step 1504, a table search is performed for a nonlinear gain from the absolute value of the difference.

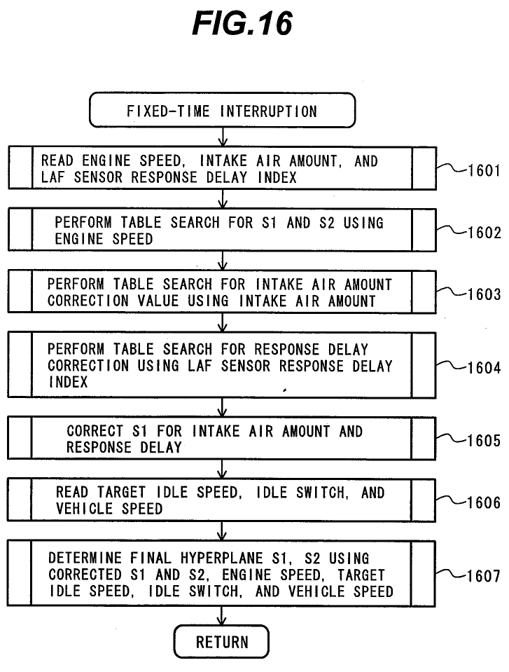

FIG. 16 is a typical flowchart showing details of the block diagram of FIG. 7. In step 1601, the engine speed, the intake air amount, and the LAF sensor response delay index are read. In step 1602, a table search is performed for S1 and S2 of the hyperplane using the engine speed. In step 1603, a table search is performed for the intake air amount correction value using the intake air amount. In step 1604, a table search is performed for the response delay correction using the LAF sensor response delay index. In step 1605, the intake air amount correction and the response delay correction are made for S1. In step 1606, the target idle speed, the idle switch, and the vehicle speed are read. In step 1607, S1 and S2 are finally fixed for the final hyperplane based on the corrected S1 and S2, the engine speed, the target idle speed, the idle switch, and the vehicle speed.

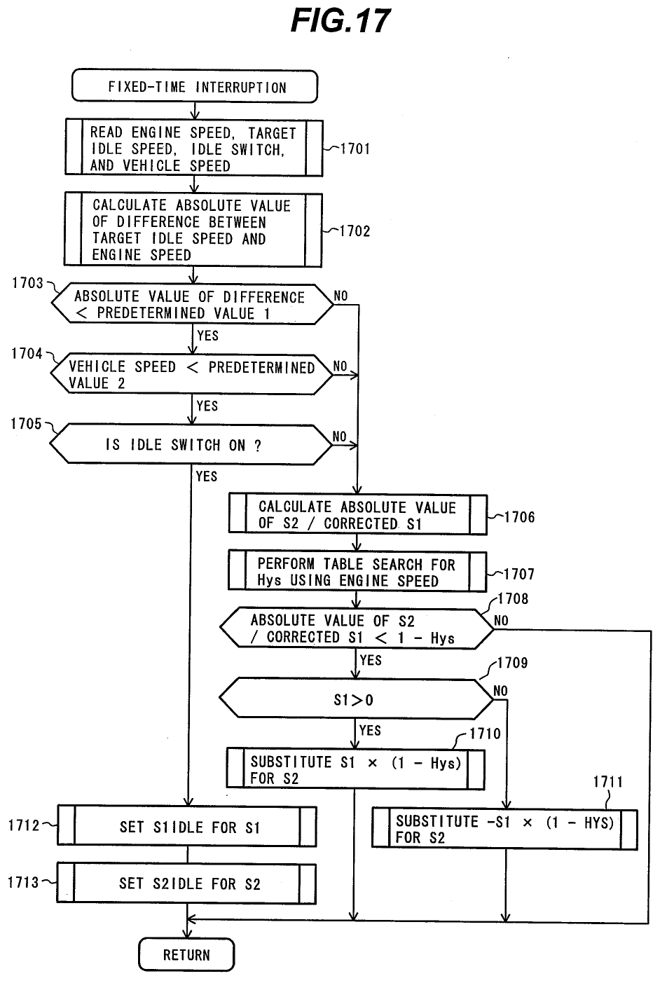

FIG. 17 is a typical flowchart showing details of the block diagram of FIG. 8. In step 1701, the engine speed, the target idle speed, the state of the idle switch, and the vehicle speed are read. In step 1702, the absolute value of the difference between the target idle speed and the engine speed is calculated. In steps 1703, 1704, and 1705, it is determined whether the absolute value of the difference is less than a predetermined value of 1, whether the vehicle speed is less than a predetermined value of 2, and whether the idle switch is ON. If all of these are true, S1IDLE is set for S1 and S2IDLE is set for S2 in steps 1712 and 1713, respectively. If any of the foregoing conditions is false, the operation branches to steps 1706 to 1711. In step 1706, the absolute value of a value obtained from S2 divided by the corrected S1 is calculated. In step 1707, a table search is performed for Hys using the engine speed. In step 1708, it is determined whether the absolute value of the divided value is smaller than 1−Hys. If it is determined that the absolute value is greater than (or equal to) 1−Hys, it is determined in step 1709 whether S1 is positive or negative. If it is determined that S1 is negative, −S1×(1−Hys) is substituted for S2 in step 1711, and if it is determined that the S1 is positive, S1×(1−Hys) is substituted for S2 in step 1710.

What is claimed is:

1. An engine control apparatus comprising:
means for detecting the oxygen concentration of an exhaust gas of an engine;
means for calculating a target air-fuel ratio according to the operating state of the engine;
means for providing feedback control by sliding mode control to achieve the target air-fuel ratio using the output from the means for detecting the oxygen concentration;
means for reflecting in the feedback control the behavior of a transfer system during the time interval between the combustion of the injected fuel and the detection of the oxygen concentration; and
means for varying a hyperplane according to the state of the transfer system.

2. The engine control apparatus according to claim 1,
wherein the means for varying the hyperplane stores in advance a region of the hyperplane in which the sliding mode control is stable and varies the hyperplane within said region.

3. The engine control apparatus according to claim 1,
wherein the state of the transfer system is delay of the exhaust gas in reaching the means for detecting the oxygen concentration of the exhaust gas due to an engine speed.

4. The engine control apparatus according to claim 1,
wherein the state of the transfer system is response delay of the means for detecting the oxygen concentration that varies with the flow rate of the exhaust gas.

5. The engine control apparatus according to claim 1,
wherein the state of the transfer system is a response change of the means for detecting the oxygen concentration as caused by deterioration with time or the like.

6. The engine control apparatus according to claim 1,
wherein the region of the hyperplane in which the sliding mode control is stable has a predetermined margin relative to a theoretically derived range.

7. The engine control apparatus according to claim 1,
wherein the means for varying the hyperplane limits one or more elements constituting the hyperplane, if the hyperplane is set so as to deviate from the range, in which the sliding mode control is said to be stabilized.

8. The engine control apparatus according to claim 1,
wherein the hyperplane is varied such that the apparent gain of feedback control is smaller in a range in which the transfer system is slower to respond than in a range in which the transfer system is quick to respond.
